(19) United States
(12) Patent Application Publication
(10) Pub. No.: US 2007/0151920 A1
(43) Pub. Date: Jul. 5, 2007

(54) System and method of micromolded filtration microstructure and devices

(76) Inventor: Ronald J. Kay, Barrington, IL (US)

Correspondence Address: VALAUSKAS & PINE LLC, Suite 4130, One North Wacker Drive, Chicago, IL, 60606, US

(21) Appl. No.: 11/634,715

(22) Filed: Dec. 6, 2006

Related U.S. Application Data
(60) Provisional application No. 60/742,673, filed on Dec. 6, 2005.

(51) Int. Cl. B01D 24/00

(52) U.S. Cl. 210/500.1

(57) ABSTRACT

Filtration microstructure comprises a micromolded layer including a support element and a filter element that creates a tortuous channel with an inlet surface of openings and an outlet surface of openings for filtering matter. Microstructure layers can be stacked upon one another creating a labyrinth network of tortuous channels. The openings of the filtration microstructure are micromolded between and including 30 micron and 1200 micron. The support element, or wall thickness, between channels is between and including 90 micron and 3600 micron. Thus, the wall thickness to channel opening ratio is between and including 1:1 and 10:1, with a preferred ratio at 3:1. The filtration microstructure enhances and facilitates flow or navigation of particles to pass. Additionally, micro-filter assemblies with an integrated frame and filtration microstructure can be micromolded. Micromolding filtration microstructure eliminates the processing and manufacturing of filtration devices and materials including woven and extruded material.

### RELATED APPLICATIONS

This application claims the priority of U.S. Patent Application Ser. No. 60/742,673 filed on Dec. 6, 2005, incorporated herein by reference.

### FIELD OF THE INVENTION

The present invention relates generally to filtration and more particularly, to a system and method of micromolded filtration microstructure.

### BACKGROUND OF THE INVENTION

Various types of filters are used for sieving matter, including fluids. Filters commonly separate smaller particles of matter from larger particles of matter. Matter can be solid, semi-solid or liquid. Filters are widely used in liquid and solid separation, gas filtration and dust collection. Filters provide a plurality of pores, or holes, through which particles (liquid or solid) must navigate to pass. Those particles not sized small enough to pass through the pores are trapped and thus separated out. The pore size, shape and quantity each vary amongst filters.

Filters come in many shapes and sizes depending on the desired application. Filters are used in a wide variety of applications, including medical, industrial and automotive. Each specific application calls for a filter with a determined pore size. Some medical applications require filters with nominal pore sizes, whereas some industrial applications require filters with considerable pore sizes.

Filters with nominal pore sizes are most used in medicine and biotechnology to separate and collect very small particles, such as cells, suspended or dissolved in a fluid. For purposes such as these, micro-filters are desired. Micro-filters have pore sizes approximately one micron or larger, creating thin walled cross sections. A micron, also termed micrometer, is a unit of length equal to one millionth (10⁻⁶) of a meter.

Filters and micro-filters are commonly constructed from a woven material, for example nylon, polyester, and polypropylene, to create a screen-type structure, or mesh. The woven material creates a surface of pores, typically square shaped. Although micro-filters can be made from woven materials, a problem is that the material can shift creating inconsistent pore sizes and an erratic mesh. Thus, a material that is more rigid is desirable such that “shifting” is not a problem.

Some meshes are manufactured by extrusion. Extrusion creates a screen-type structure, without the woven characteristic. A molten material, such as metal or plastic is pressed or pushed out of a mold, or die. Extrusion does not allow for small pore sizes required by micro-filters.

Most filter devices include a rigid frame to support the screen-type structure. An example of a prior art filter device can be seen at U.S. Pat. No. 5,427,742 to Holland. The rigid frame and mesh is molded to form a unitary piece, or filter device. Typically, the mesh is cut to size and inserted into the mold cavity of the tool. A molten material, or resin, is injected into the mold cavity to create the frame. The frame and screen are joined together. Manufacturing of filter devices consisting of a rigid frame and an insert-molded mesh is complex when it comes to precisely placing the screen-type structure into the mold cavity.

Other types of filter devices have been manufactured from molding plastic material into flat sheets having slots or holes therein, which are then roll formed into a cylinder having a seam where the two ends of the sheet are bonded, or joined. Such a filter is disclosed in U.S. Pat. No. 4,406,326 to Wagner.

Other filters are injection molded, like those of U.S. Pat. No. 4,882,055 to Stamsted and U.S. Pat. No. 5,256,360 to Li. The Stamsted filter is made of injection molded openings, or microholes, that are created via machine projections on the mold cavity surface. Typically, it is difficult to create projections on a mold cavity surface that allow for injection molded fine openings. Stamsted discloses the use of standard engraving equipment to create machine projections on the cavity surface to form microholes. Additionally, the Li filter discloses injection molded holes created by machine rod-like protrusions on the mold cavity surface. Both the Stamsted patent and Li patent disclose one layer of injection molded holes, but various applications exist that require fine openings other than a hole for sieving matter. Furthermore, the manufacturing techniques to create fine openings disclosed in Stamsted and Li are expensive and non-economical.

Micro-sized parts, typically parts with an overall largest dimension of less than one millimeter, can be injection molded. The injection molding of these micro-sized parts is known as micromolding. Micromolding is a process that allows for the manufacture of small parts, for example 2 mm long.

There remains a demand for improved filtration microstructure, for improved methods for manufacturing such filtration microstructure and apparatuses, or devices, employing such filtration microstructure. The present invention satisfies this demand.

### SUMMARY OF THE INVENTION

Eliminating the processing and manufacturing of insert molded and extruded material for filtration assemblies, injection micromolding technology allows for filtration of microstructure. Small geometries can be created using advanced tool micro-machining technology on a mold cavity surface, such as Electrical Discharge Machining (EDM), Micro Electrical Discharge Machining (MEDM), or machining by laser beam or electron beam. Micro-machining technology works by eroding material in the path of electrical discharges that form an arc between an electrode tool and the work piece, or part. Micromolding technology is one of the most accurate manufacturing processes currently available for creating small geometries within parts and assemblies.

Injection micromolding is less expensive than current manufacturing of filtration devices. Injection micromolding filtration microstructure and devices is simpler than other manufacturing processes in that it requires fewer processing steps, thus providing a higher quality product. Filtration microstructure and devices can be manufactured with a one-shot molding process or a two-or-more shot injection molding process.

An object of the present invention is to provide a filtration microstructure that enhances and facilitates flow or navigation of particles to pass. Filtration microstructure can comprise a single layer or multiple layers, with each layer including a filter element and support element, otherwise referred to herein as wall thickness. Filter, or filtration, elements can be of any cross-sectional configuration including dimension, quantity and shape, for example, rectangular, square, circular, and triangular. The filter elements of one layer or a plurality of layers forms a channel through which matter is sieved. Thus, the cross-sectional configuration of the channels may vary throughout the channel. The channels define an inlet surface of openings and an outlet surface of openings, which can further vary by dimension, quantity, and shape.

Another object of the present invention is to provide filtration microstructure that defines a labyrinth network of tortuous channels, or mesh, for improving efficiency of filtration. The channels define an inlet surface of openings and an outlet surface of openings. The openings of the filtration elements are micromolded between and including 30 micron and 1200 micron for micro-filter applications. The support elements, or wall thickness, between the channel openings is between and including 90 micron and 3600 micron. A micron, also termed micrometer, is a unit of length equal to one millionth (10-6) of a meter. Thus, the wall thickness to channel opening ratio is between and including 1:1 and 10:1, with a preferred ratio at 3:1. Maintaining this ratio allows for higher flow rates through the micro-filter assembly. Higher flow rates reduce wear on the core pins of the tool and extend the usable life of the tool without compromising rigidity of the filtration microstructure.

Another object of the present invention is to provide a filter with microstructure that is micromolded with sufficiently rigidity such that it does not shift, which causes inconsistent pore sizes and an erratic channel structure.

Another object of the present invention is to provide depth filtration, or a plurality of microstructure layers substantially abutting one another, i.e., stacked. Stacked microstructures upon one another, thus overlapping, create improved efficiency of holding capacity to capture contamination during filtration. As the filter traps contamination, the efficiency of the holding capacity of smaller contamination particles is not compromised.

It is a further object of the present invention to reduce cost of manufacturing micro-filter assemblies with depth filtration, while increasing accuracy of the manufacturing process, using a multiple shot (two-shot, three-shot or more) injection micromolding process. Depth filtration can be manufactured in a variety of ways. One method to create depth filtration is to individually manufacture microstructure layers, and then stack each layer upon one another. Any method can be used to assemble the individually manufactured layers into a stacked configuration of depth filtration microstructure, for example, adhesive or welding including sonic, spin and vibration welding. Likewise, conical or oblong filtration microstructure can be stacked upon one another to create depth filtration. Another method of creating depth filtration microstructure is to manufacture two layers using a two-shot micromolding process. For example, a first filtration microstructure layer is molded, the mold rotates in the tool and a second layer is molded adjacent to the previously molded first filtration microstructure layer. A third filtration microstructure layer can be manufactured in the same manner. It is contemplated that any number of layers can be stacked upon one another.

It is another object of the present invention to increase the life of the micro-filter assembly by increasing the filtration area with a depth filtration, or stacked, configuration. The filtration microstructure can be stacked upon the same or different filtration microstructure. This labyrinth network of tortuous channels with micron openings is multidirectional to enhance and facilitate flow. Furthermore, the particles that are trapped, or not sized to pass through the network of tortuous channels, do not block or prevent the navigation of other particles from passing. Increased filtration area increases the overall life of the filter even in the presence of significant residue or caking.

Yet another object of the present invention is to provide a one-shot molding process that creates filter microstructure integrated with a rigid frame that improves upon manufacturability. The rigid frame and microstructure of micro-filter assemblies can be molded simultaneously. The rigid frame and filtration microstructure can be created from the same material with different curing, or processing, times. For example, the prior art filter assembly seen at U.S. Pat. No. 5,427,742 to Holland can be manufactured with a one-shot molding process such that the rigid frame and filtration mesh is integrated and created simultaneously, thereby eliminating the manufacturing step of insert-molding the mesh.

Yet another object of the present invention is to provide a two-shot molding process that creates filter microstructure integrated with a rigid frame that improves upon manufacturability. For example, the filtration microstructure is molded first, the mold rotates in the tool and the rigid frame is molded around the previously molded filtration microstructure. The rigid frame and filtration microstructure can be created from the same or different materials with either the same or different curing time.

Another object of the present invention is to provide a rigid frame that includes microstructure, but to the extent the rigidity of the frame is not compromised. In reference to embodiments of filter microstructure integrated with a rigid frame, either manufactured with a one-shot or two-shot molding process, the frame itself may include filtration microstructure. Filtration microstructure positioned within the frame further enhances and facilitates flow of the matter being filtered.

Another object of the present invention is to provide a micro-filter assembly comprising entirely of filtration microstructure (without a rigid frame). A microstructure-only filter can be micromolded to any overall size and shape, for example cone, cylindrical, cubicle. Filtration area is increased for applications not requiring a rigid frame.

It is another object of the present invention to provide micro-filters made from a variety of materials. Microstructure filter assemblies can be made from a variety of materials, or resin, that withstand high temperatures and high-pressure differentials without distorting or destroying the microstructure. Examples of high temperature and high pressure materials include thermo set materials and thermo plastic materials, for example, Polyphenylene Sulfide (PPS) or Polyetheretherketone (PEEK) to name a few. It is further contemplated that a micro-filter assembly can be made from two or more materials.

Additional features of the invention will become apparent to those skilled in the art upon consideration of the following detailed description of preferred embodiments exemplifying the best mode of carrying out the invention as presently perceived.

### BRIEF DESCRIPTION OF THE DRAWINGS

The detailed description particularly refers to the accompanying figures in which:

FIG. 1 is a side sectional view of a single layer filter microstructure configuration according to the present invention;

FIG. 2 is a top view of the filter microstructure configuration of FIG. 1 according to the present invention;

FIG. 3 is a side sectional view of a multiple layer filter microstructure configuration according to the present invention;

FIG. 4 is a top view of the filter microstructure configuration of FIG. 3 according to the present invention;

FIG. 5 is a side sectional view of another embodiment of a multiple layer filter microstructure configuration according to the present invention;

FIG. 6 is a top view of the filter microstructure configuration of FIG. 5 according to the present invention;

FIG. 7 is a side sectional view of another embodiment of a multiple layer filter microstructure configuration according to the present invention;

FIG. 8 is a top view of the filter microstructure configuration of FIG. 7 according to the present invention;

FIGS. 9A-9F are planar views of various flat filtration microstructure mesh configurations according to the present invention;

FIGS. 10A-10D are planar views of various cylindrical filtration microstructure mesh configurations according to the present invention;

FIG. 11 is a planar view of a cylindrical micro-filter device according to the present invention;

FIG. 12 is a planar view of a top portion of a micro-filter device as shown in according to the present invention;

FIG. 13 is a planar view of a bottom portion of a micro-filter device according to the present invention; and

FIG. 14 is a planar view of a conical micro-filter device according to the present invention.

### DETAILED DESCRIPTION OF THE INVENTION

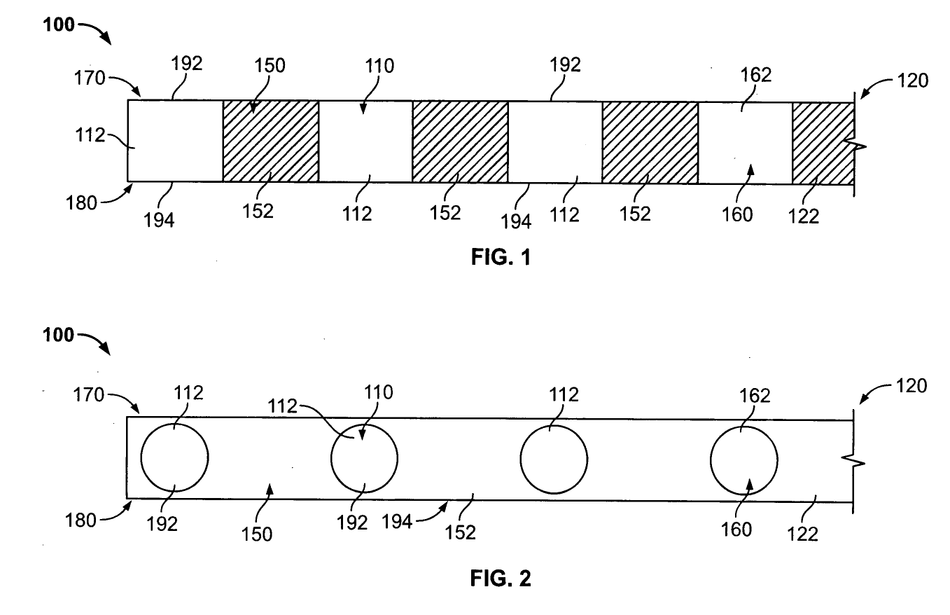

FIGS. 1 and 2 illustrate a single layer filtration microstructure assembly 100 that includes a microstructure layer 120. Layer 120 is created by a one-shot molding process and includes a support element 150 and a filter element 110 that create a tortuous channel 160. More specifically, FIGS. 1 and 2 illustrate a single layer of microstructure 122 that includes a plurality of support elements 152 and a plurality of filter elements 112. The filter elements 112 create tortuous channels 162 to filter matter. The channels 162 define an inlet surface 170 of openings 192 and an outlet surface 180 of openings 194.

As shown in FIG. 2, channel 162 is cross-sectionally depicted as a straight-through hole configuration from the inlet surface 170 to outlet surface 180, although any configuration is contemplated, for example, a configuration with an inlet opening 192 of different size and/or shape compared to the outlet opening 194 of the channel 162, thus varying the cross-sectional geometry, or surface shape, of the channel 162. The inlet surface 170 of layer 122 receives matter, and upon filtration through the channel 160, exits the outlet surface 180.

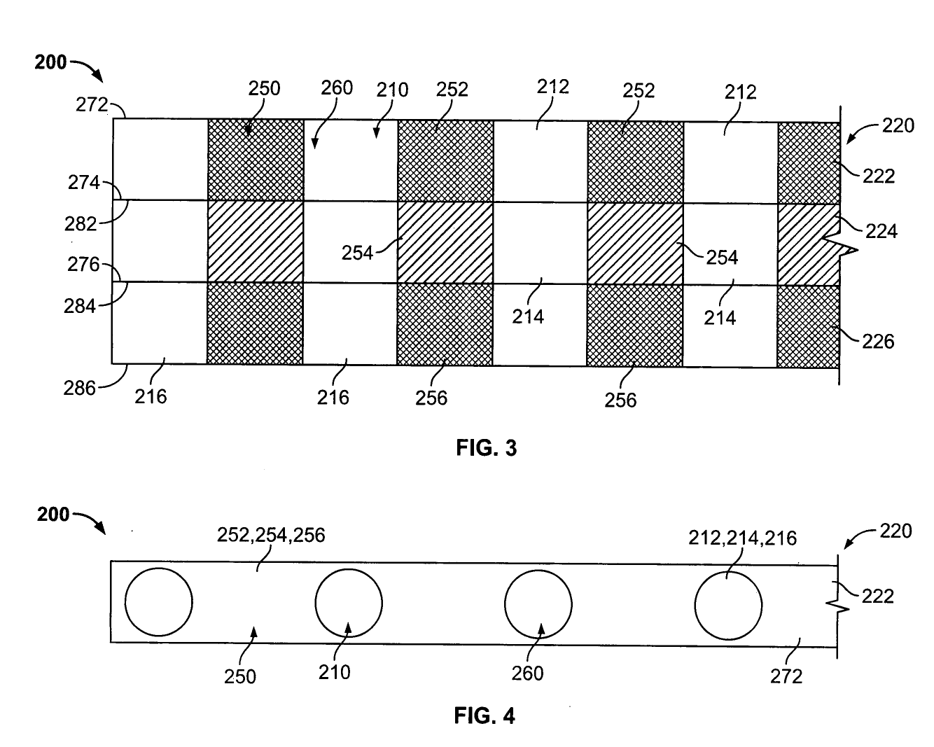

FIGS. 3 and 4 illustrate a multiple layer filtration microstructure assembly 200. The assembly 200 includes a plurality of microstructure layers 220 created by successive shot molding process. Each layer 220 includes a support element 250 and a filter element 210.

A first-shot molding process creates a first layer 222 with a plurality of support elements 252 and a plurality of filter element 212. A second-shot molding process creates a second layer 224 with a plurality of support elements 254 and a plurality of filter element 214. A third-shot molding process creates a third layer 226 with a plurality of support elements 256 and a plurality of filter element 216.

Each layer 222, 224, 226 is stacked upon one another, thus overlapping to create depth filtration. The outlet surface 282 of the first layer 222 substantially abuts the inlet surface 274 of the second layer 224. The outlet surface 284 of the second layer 224 substantially abuts the inlet surface 276 of the third layer 226.

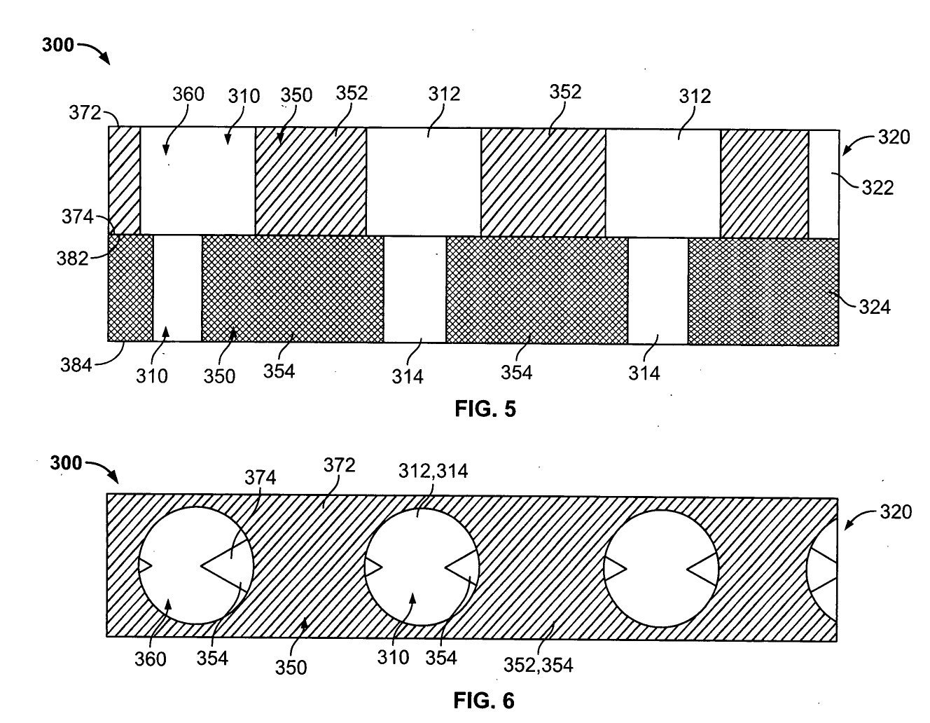

The combination of filter elements 212, 214, 216 of each layer 222, 224, 226 creates a tortuous channel 260. The inlet surface 272 of the first layer 222 receives matter, and upon filtration through the channel 260, exits the outlet surface 286 of the third layer 226. Again, although channel 260 is cross-sectionally depicted as a straight-through hole configuration in FIG. 4, any configuration is contemplated, as shown more fully in reference to FIGS. 5-8.

FIGS. 5 and 6 illustrate a multiple layer filtration microstructure assembly 300 created by a successive two-shot molding process. Each layer 320 includes a support element 350 and a filter element 310.

A first-shot molding process creates a first layer 322 with a plurality of support elements 352 and a plurality of filter element 312. A second-shot molding process creates a second layer 324 with a plurality of support elements 354 and a plurality of filter element 314.

Each layer 322, 324 is stacked upon one another creating depth filtration. The outlet surface 382 of the first layer 322 substantially abuts the inlet surface 374 of the second layer 324.

The combination of filter elements 312, 314 of each layer 322, 324 creates a tortuous channel 360. The inlet surface 372 of the first layer 322 receives matter, and upon filtration through the channel 360, exits the outlet surface 384 of the second layer 324. As shown in FIG. 6, the channel 360 is not a straight-through hole configuration, but multidirectional.

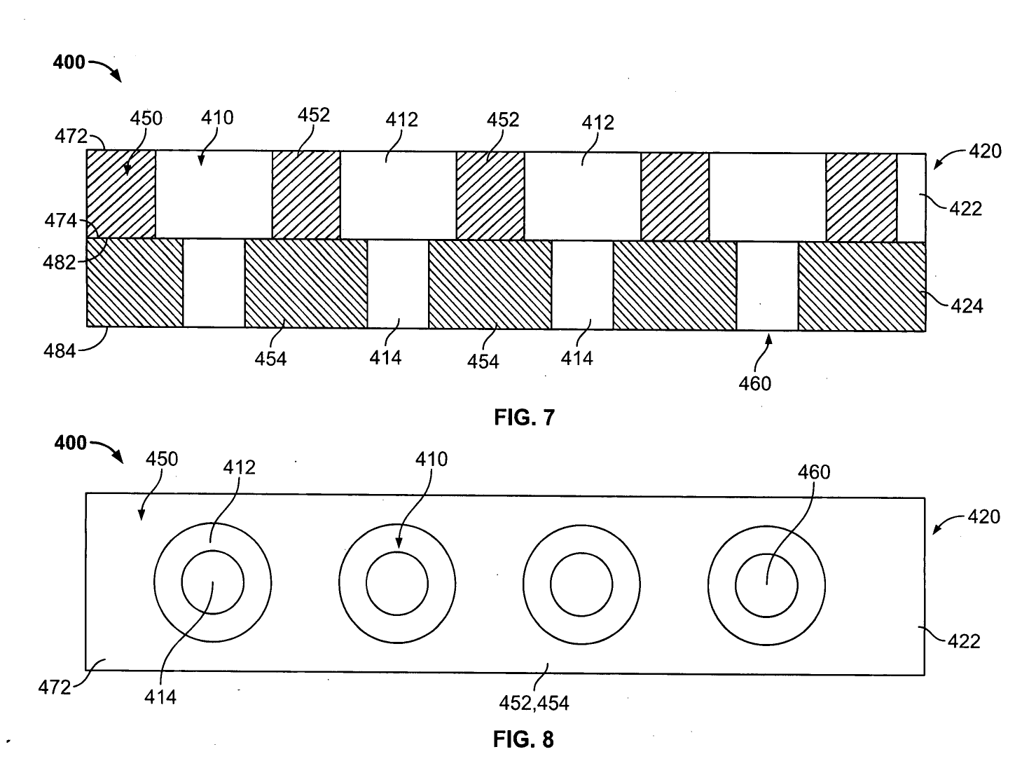

Another embodiment of a multiple layer filtration microstructure assembly 400 is shown in FIGS. 7 and 8. A successive two-shot molding process creates layers 422 and 424, each with filter elements 412, 414 and support elements 452, 454.

Each layer 422, 424 is stacked upon one another creating depth filtration. The outlet surface 482 of the first layer 422 substantially abuts the inlet surface 474 of the second layer 424. The inlet surface 472 of the first layer 422 receives matter, and upon filtration through the channel 460, exits the outlet surface 484 of the second layer 424. As shown in FIG. 8, the channel 460 is a circular configuration, varying in dimension.

Although the embodiments described above have been in reference to a one, two and three-shot micromolding layer process, any number of layers is contemplated to create a microstructure to filter matter. In addition, it is contemplated that each layer may be different from the next in geometry including size and shape of filter elements, and likewise support elements. Thus, filtration microstructure of the present invention includes a plethora of multidirectional tortuous channel configurations.

In all embodiments, the combination of support elements of each layer creates a rigid structure to support the assembly itself. Thus, a filter assembly comprising entirely of support elements (without a rigid frame) can be micromolded with any overall size and shape, for example cone, cylindrical, cubicle. Although it is further contemplated that a frame, or rib, can be simultaneously molded in conjunction with the microstructure to further support the assembly.

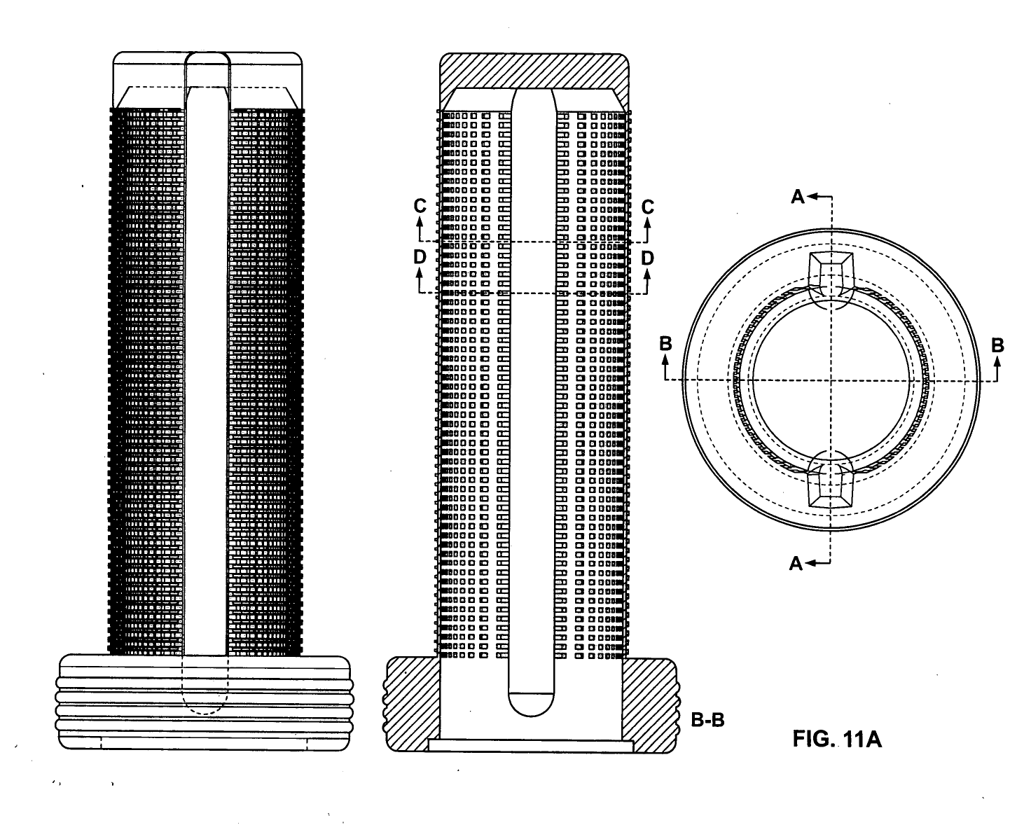

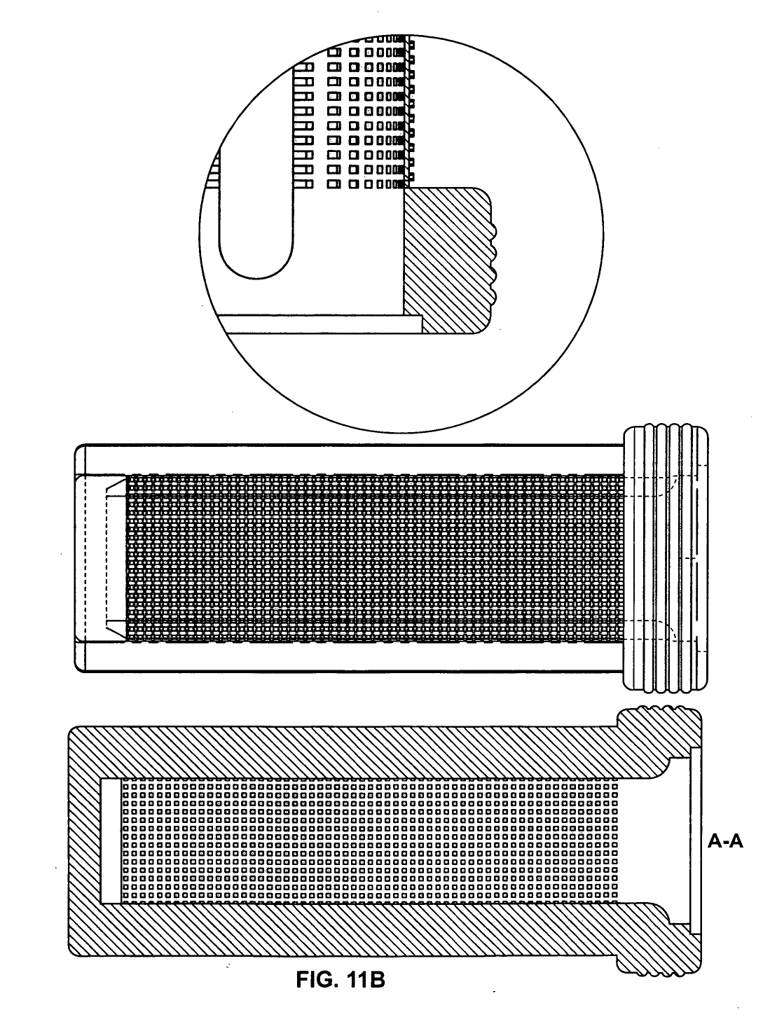

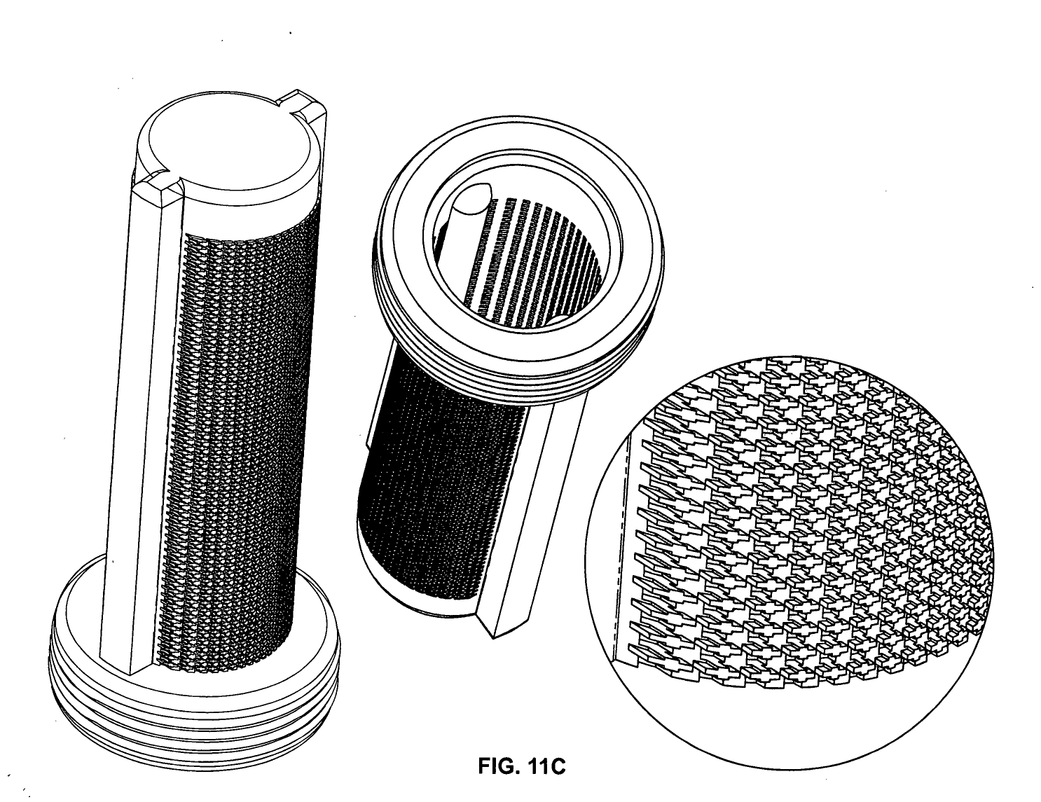

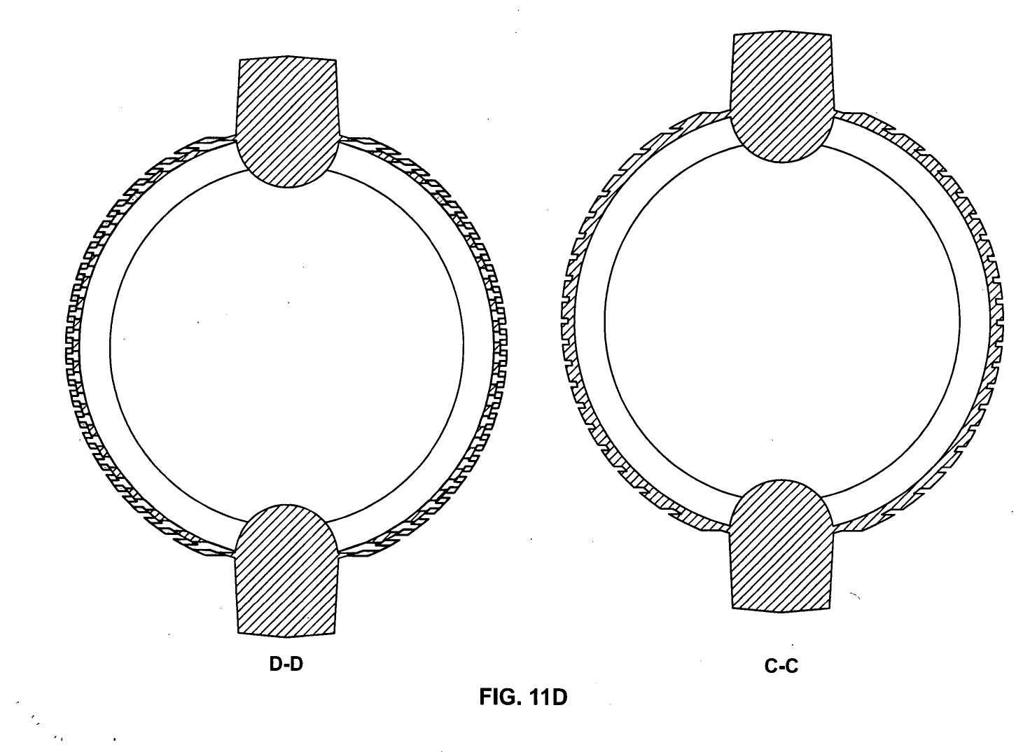

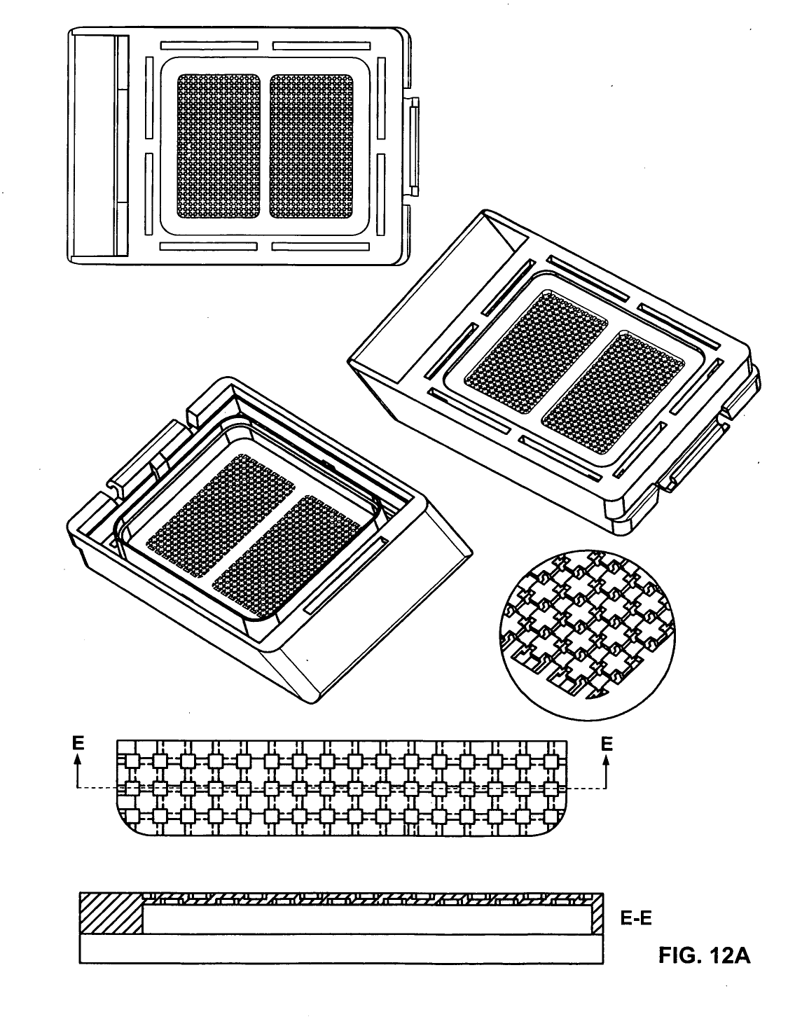

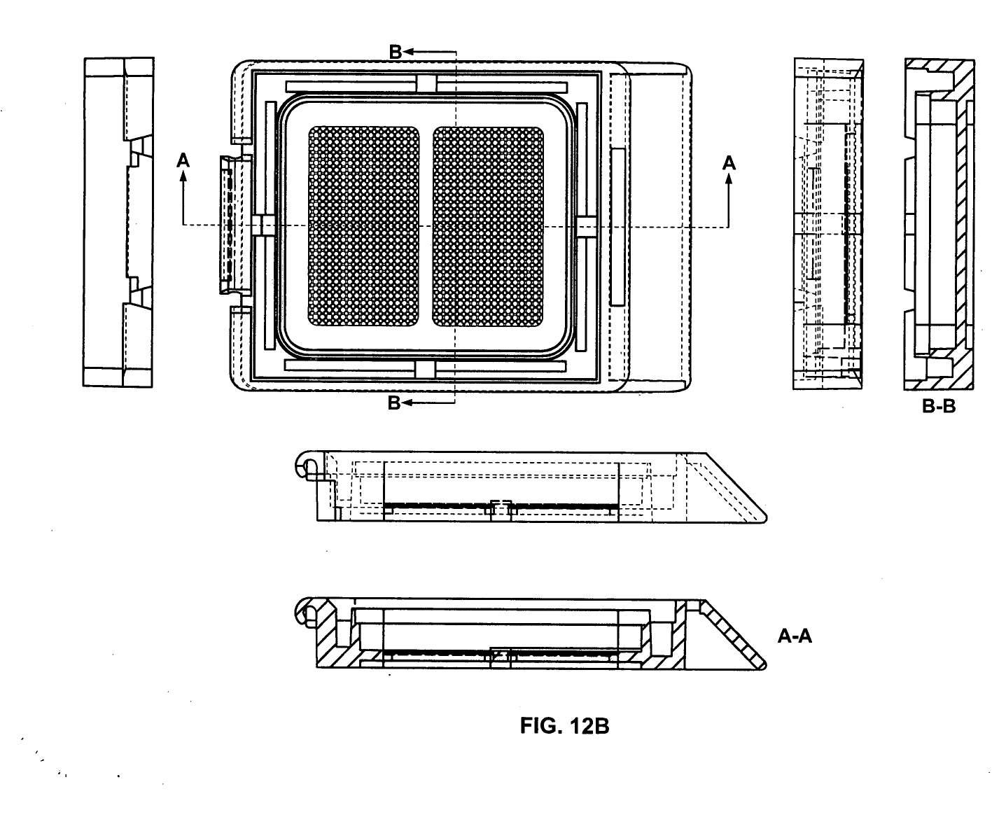

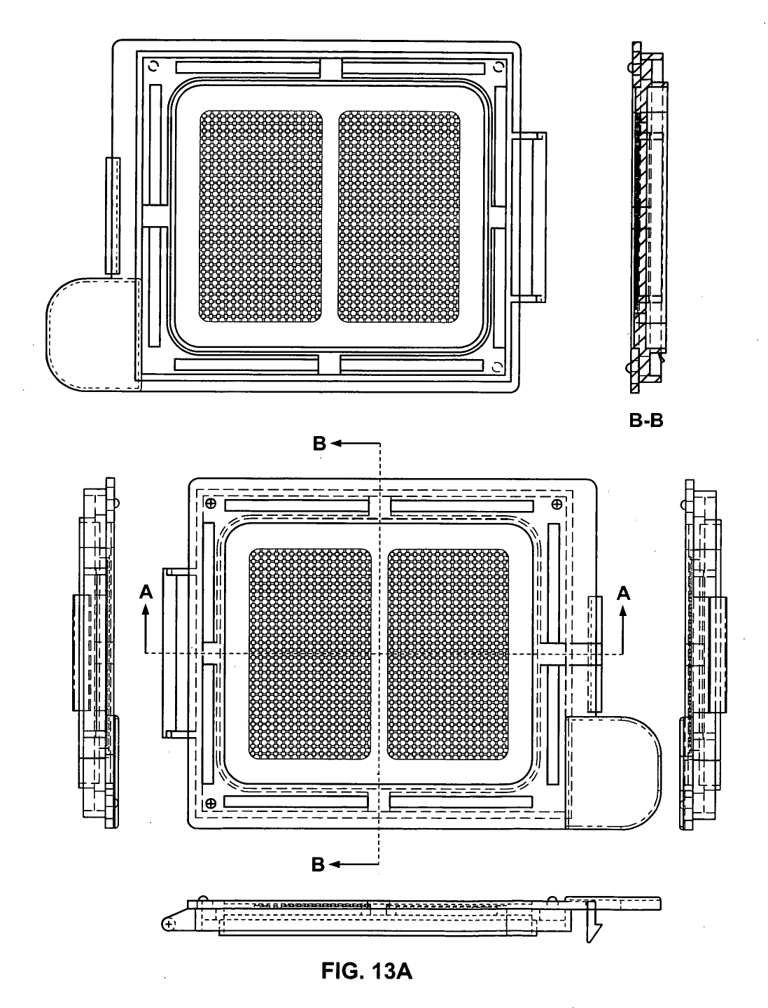

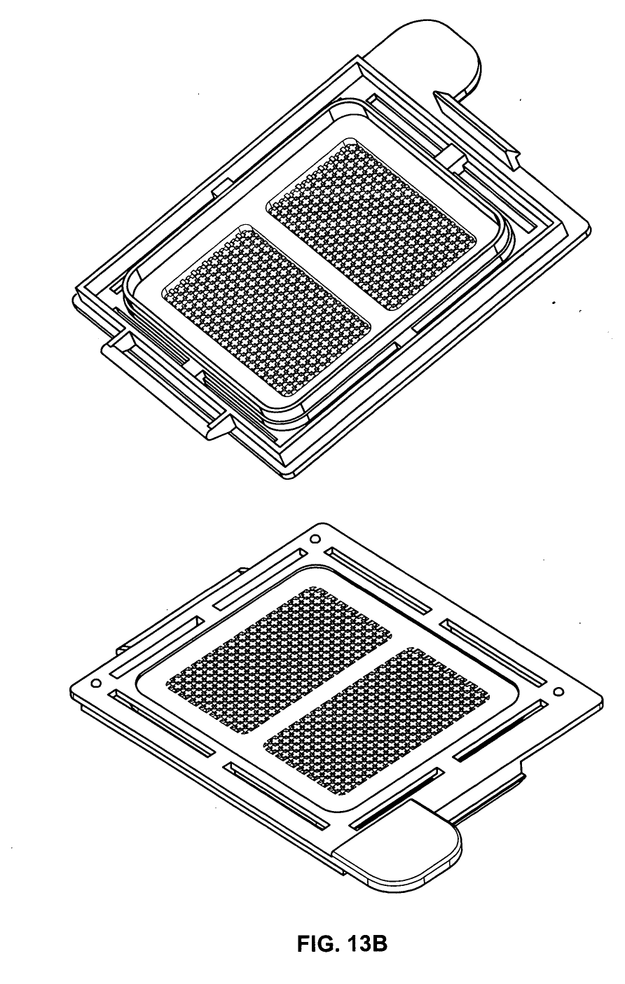

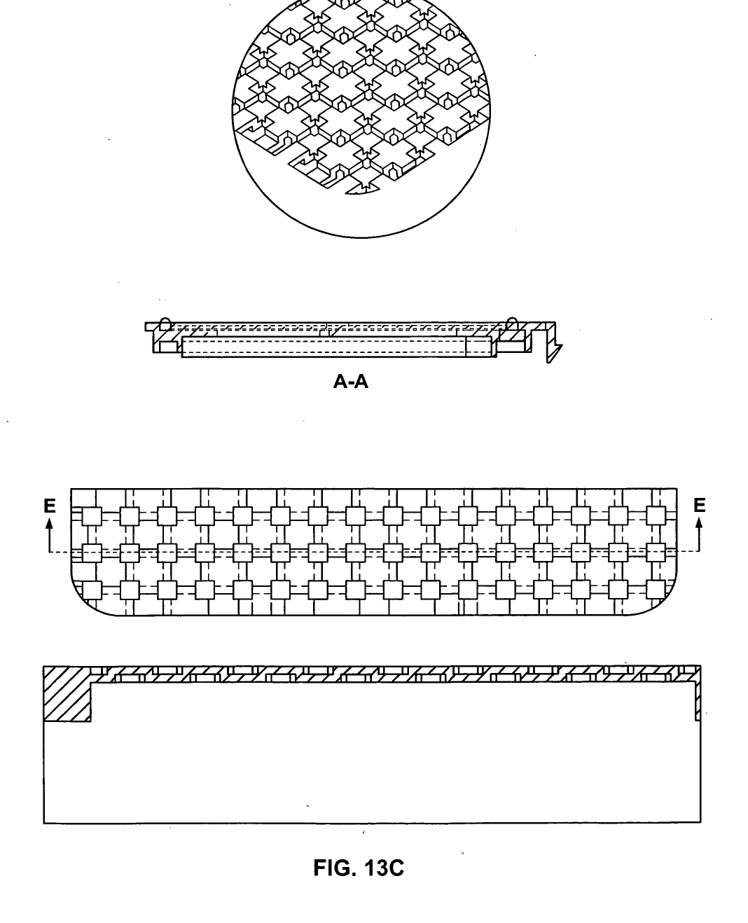

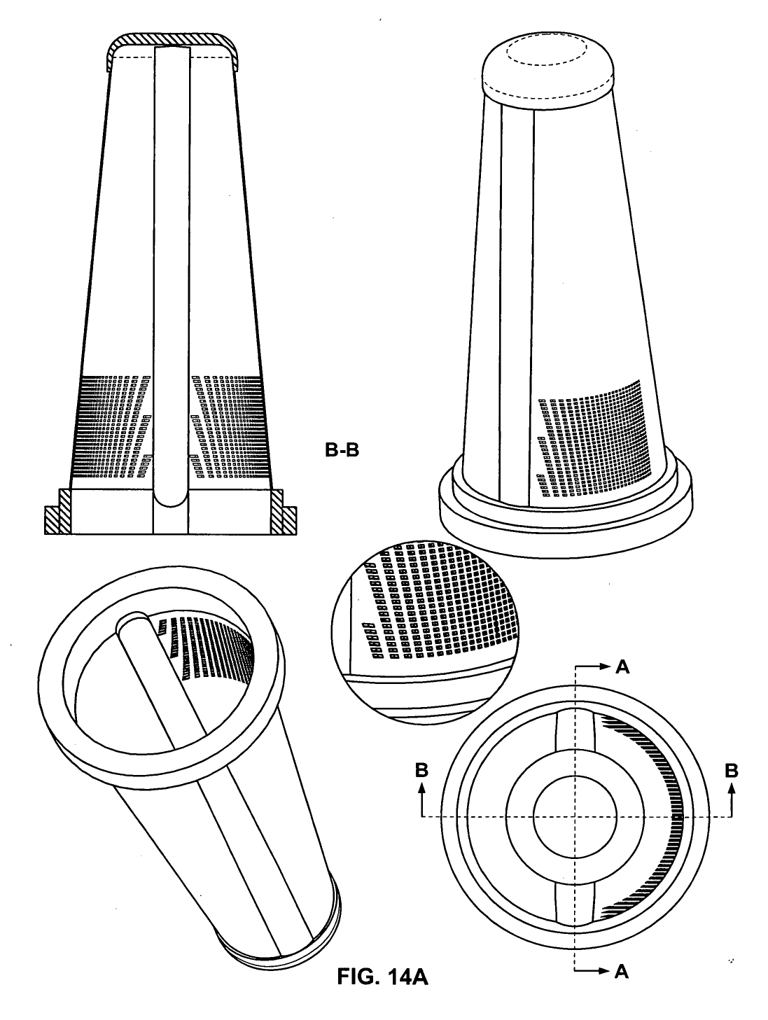

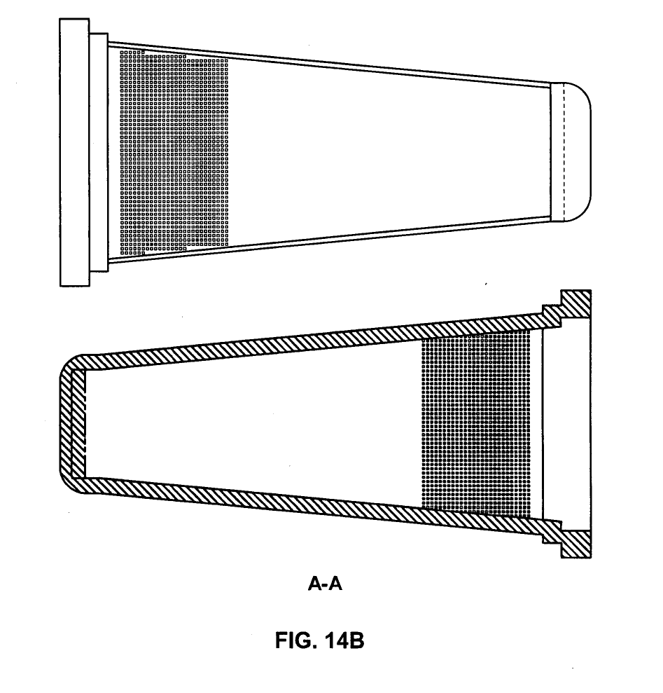

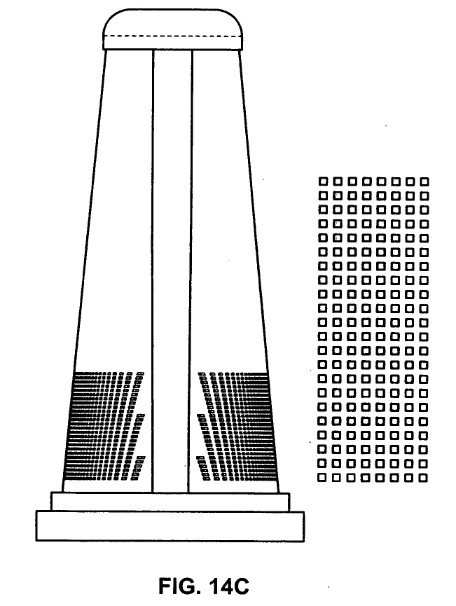

For example, manufacturing a micro-filter device with an integrated frame and filtration microstructure can be created with a two-shot molding process. For example, the filtration microstructure is molded first, the mold rotates in the tool and the rigid frame is molded around the previously molded filtration microstructure. The rigid frame and filtration microstructure can be created from the same or different materials with either the same or different curing time. Examples of a micro-filter device with an integrated frame that can be manufactured with a two-shot molding process are illustrated in FIG. 11, FIG. 12, FIG. 13, and FIG. 14.

Other examples of micro-filter devices that can be manufactured in a one-shot molding process are illustrated in FIG. 11 and FIG. 14.

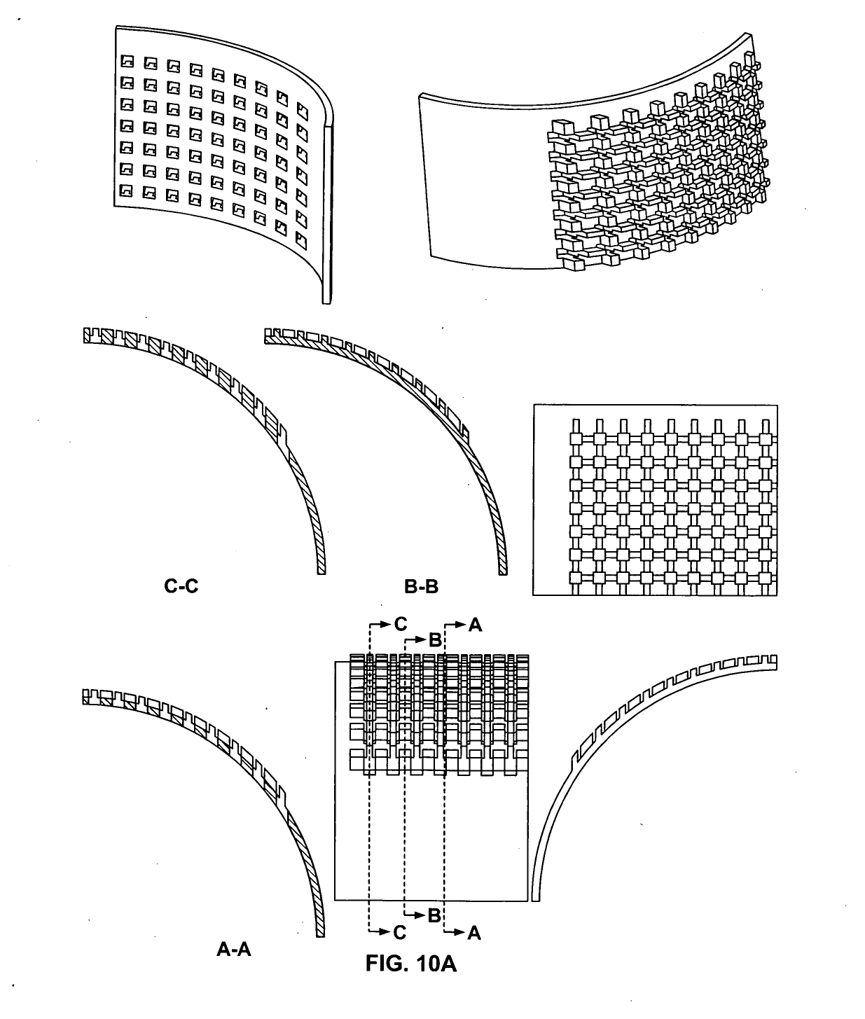

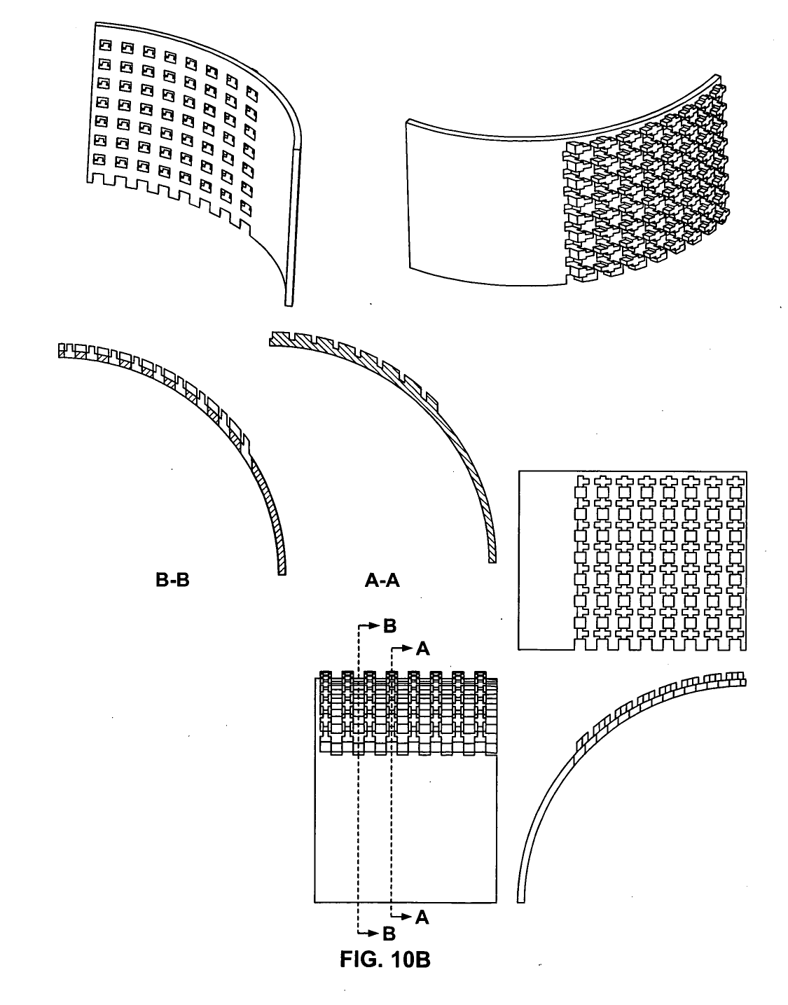

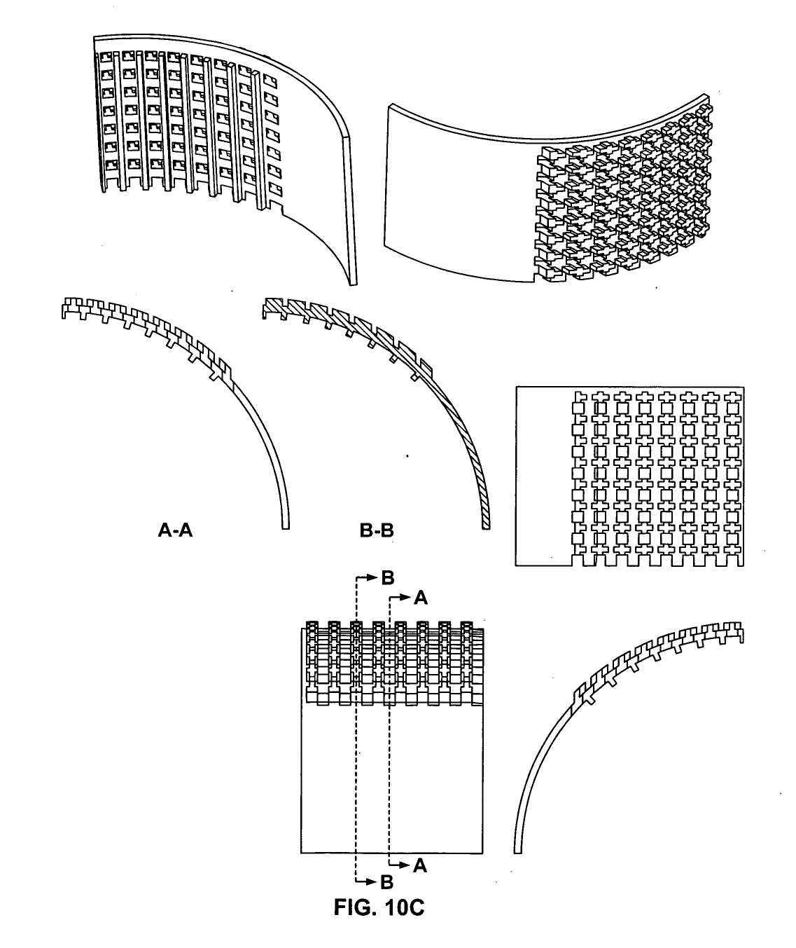

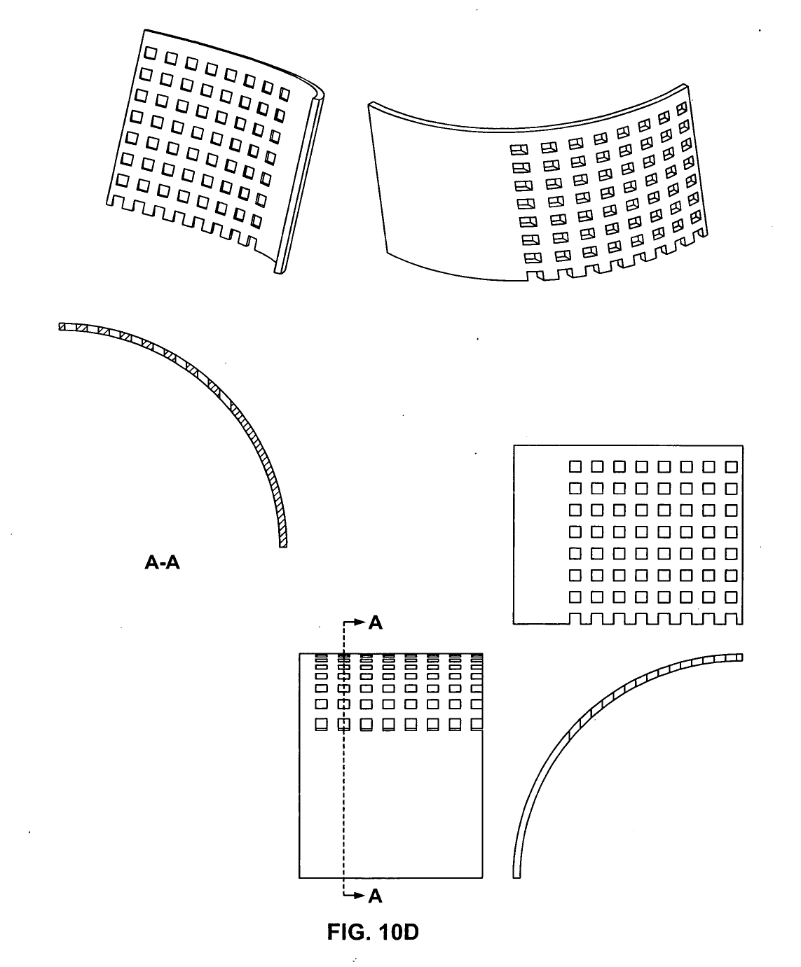

The entire filtration microstructure can be flat (see FIGS. 9A-9F, FIG. 12, FIG. 13 and FIGS. 1-8), cylindrical (see FIGS. 10A-10D and FIG. 11), cone (see FIG. 14) or oblong to name a few.

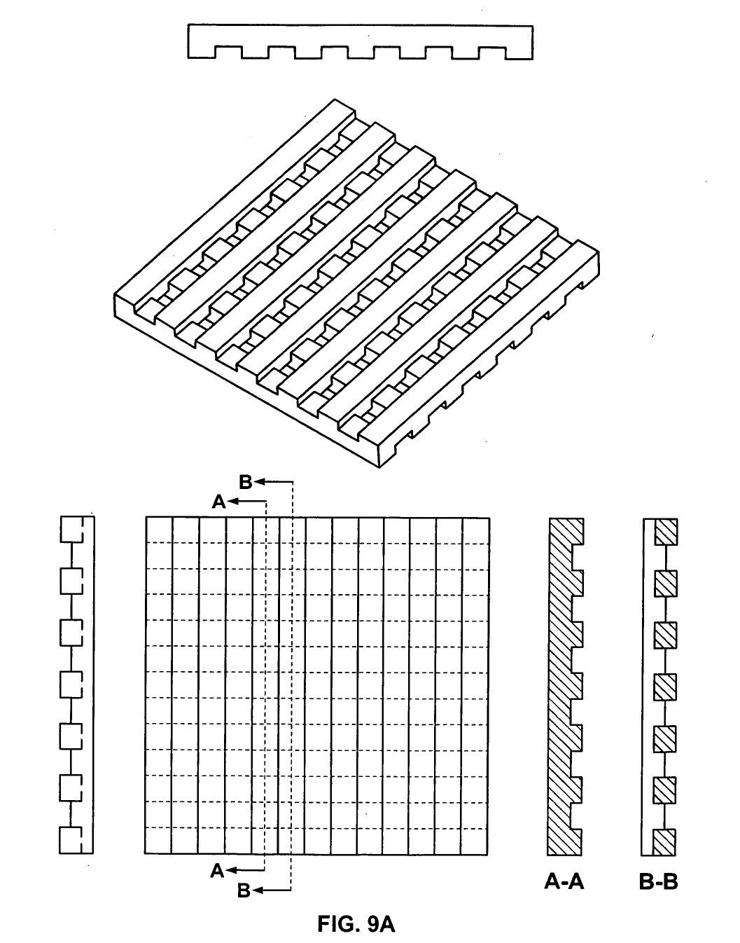

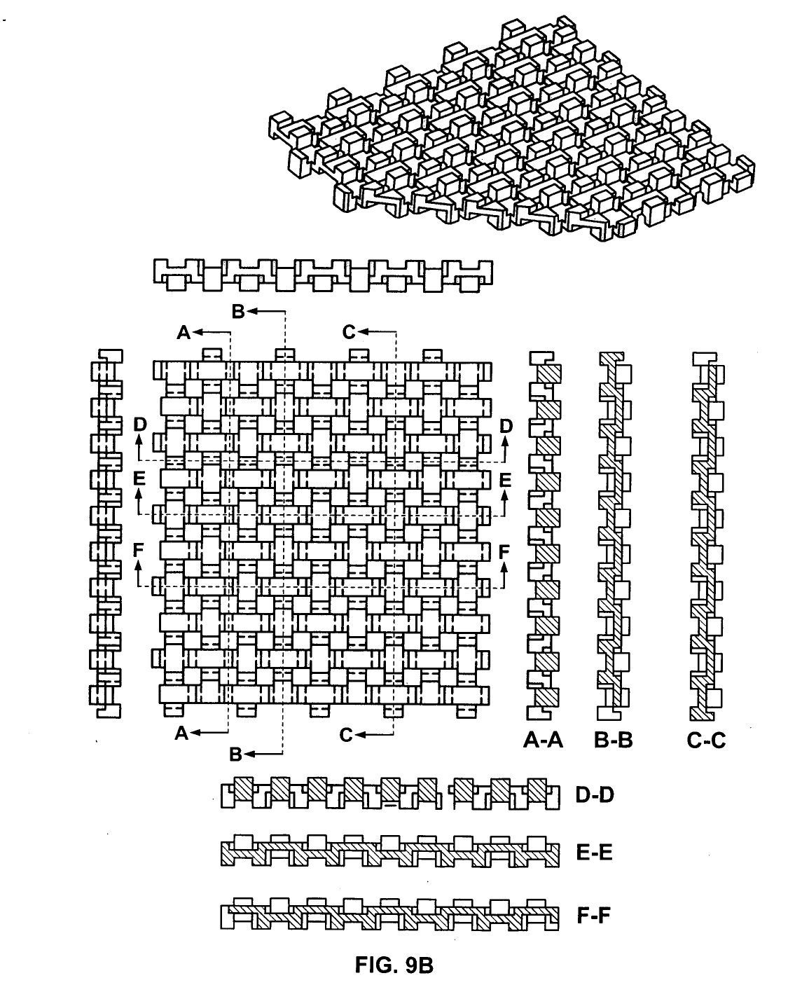

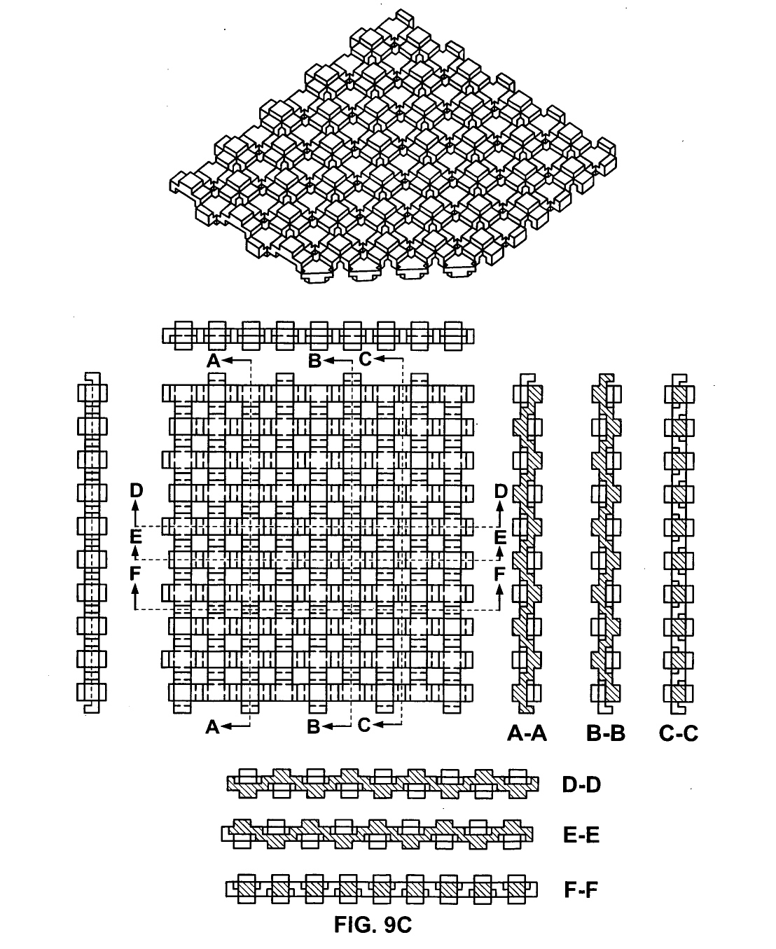

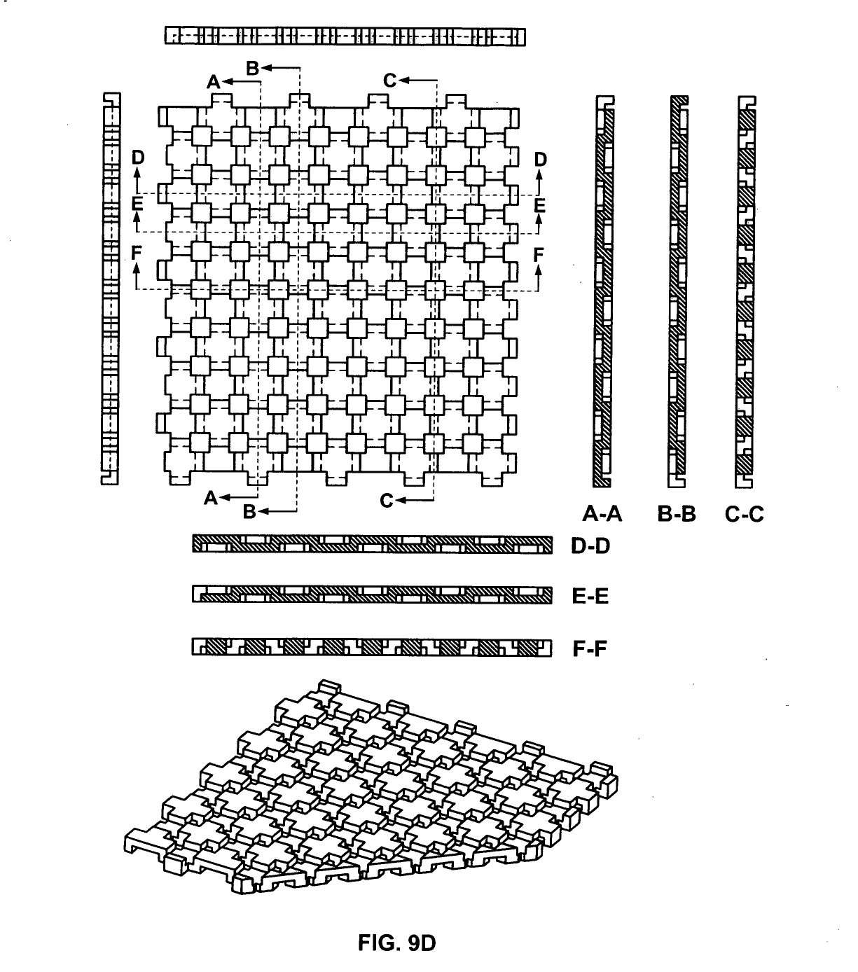

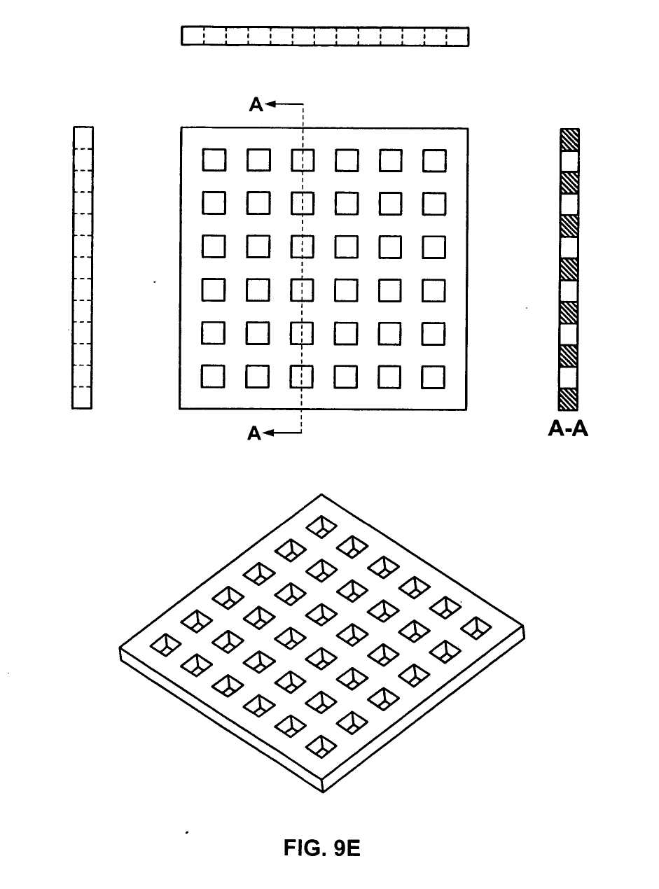

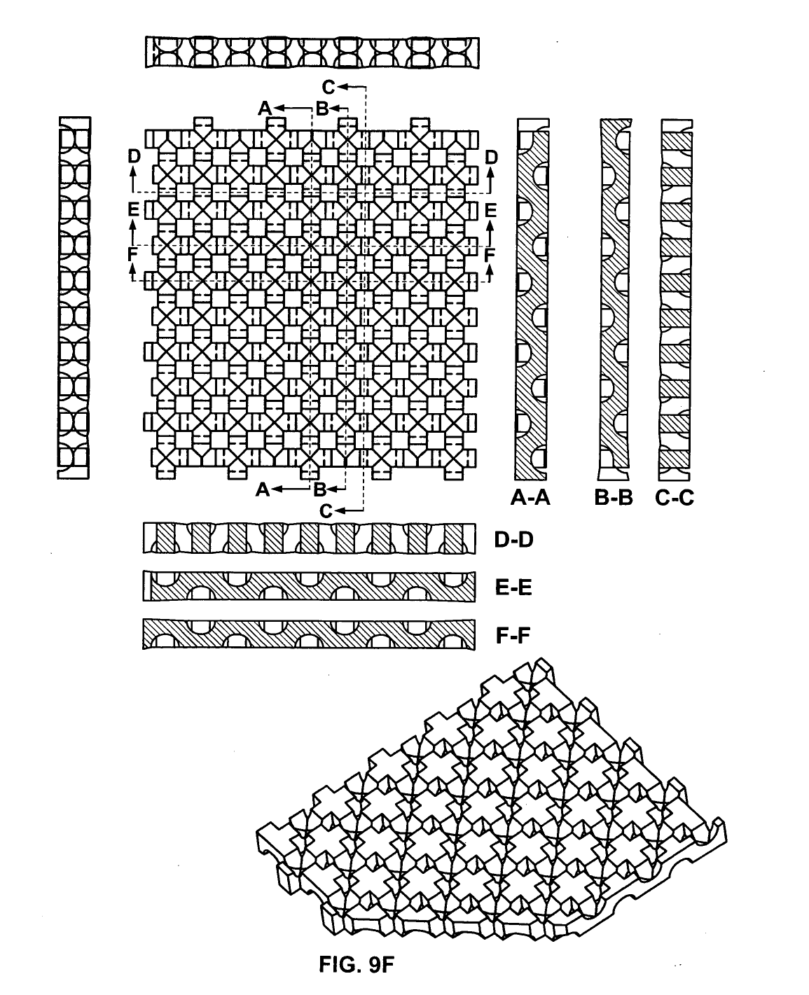

FIGS. 9A-9F illustrate various flat filtration microstructure. The flat filtration microstructure can be stacked upon one another as illustrated in FIGS. 1-8. It is further contemplated that cylindrical filtration microstructure, as shown in FIGS. 10A-10D, can be stacked upon one another to create depth filtration.

While the disclosure is susceptible to various modifications and alternative forms, specific exemplary embodiments thereof have been shown by way of example in the drawings and have herein been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

What is claimed is:

1. A system of micromolded filtration microstructure, comprising:
a network of channels, wherein said channels include a first surface of a plurality of inlet openings and a second surface of a plurality of outlet openings;
a wall thickness between said plurality of said openings; and
a ratio of said wall thickness to said openings between and including 1:1 and 10:1.

2. The system of claim 1, wherein said inlet opening is between and including 30 micron and 1200 micron.

3. The system of claim 1, wherein said outlet opening is between and including 30 micron and 1200 micron.

4. The system of claim 1, wherein said wall thickness is between and including 90 micron and 3600 micron.

5. The system of claim 1, wherein said wall thickness to said channel opening ratio is between and including 1:1 and 10:1.

6. The system of claim 5 wherein said wall thickness to said channel opening ratio is 3:1.

7. A micro-filter assembly, comprising:
a first layer of microstructure including at least one filter element and at least one support element;
a channel defined by said at least one filter element and said at least one support element, wherein said channel has an inlet opening and an outlet opening and said channel varies in geometry from said inlet opening to said outlet opening.

8. The micro-filter assembly of claim 7, wherein said inlet opening is between and including 30 micron and 1200 micron.

9. The micro-filter assembly of claim 7, wherein said outlet opening is between and including 30 micron and 1200 micron.

10. The micro-filter assembly of claim 7, wherein said support element is between and including 90 micron and 3600 micron.

11. The micro-filter assembly of claim 7, wherein said support element to said filter element ratio is between and including 1:1 and 10:1.

12. The micro-filter assembly of claim 11, wherein said support element to said filter element ratio is 3:1.

13. The micro-filter assembly of claim 7, wherein said assembly is conical.

14. The micro-filter assembly of claim 7, wherein said assembly is cylindrical.

15. The micro-filter assembly of claim 7, further comprising a rigid frame sustaining said first layer of microstructure.

16. A method for enhancing the facilitation of flow through a micro-filter, comprising:
providing a first layer of microstructure with a first inlet surface of first inlet openings and a first outlet surface of first outlet openings;
furnishing a second layer of microstructure with a second inlet surface of second inlet openings and a second outlet surface of second outlet openings;
assembling said first layer of microstructure with said second layer of microstructure wherein said first outlet surface substantially abuts said second inlet surface; and
filtering matter from said first inlet openings of said first inlet surface to said second outlet openings of said second outlet surface.

17. The method of claim 8, wherein said first inlet opening is between and including 30 micron and 1200 micron.

18. The method of claim 8, wherein said first outlet opening is between and including 30 micron and 1200 micron.

19. The method of claim 8, wherein said second inlet opening is between and including 30 micron and 1200 micron.

20. The method of claim 8, wherein said second outlet opening is between and including 30 micron and 1200 micron.
